(19) United States
(12) Patent Application Publication
(10) Pub. No.: US 2025/0328753 A1
(43) Pub. Date: Oct. 23, 2025

(54) ANALYZING PROMPTS TO DETERMINE LABELS FOR AUTOMATED GENERATIVE ARTIFICIAL INTELLIGENCE LABELING

(71) Applicant: Capital One Services, LLC, McLean, VA (US)

(72) Inventors: Shannon YOGERST, New York, NY (US); Purva SHANKER, Arlington, VA (US); Tania CRUZ MORALES, Washington, DC (US); Dan LIN, Arlington, VA (US); Mary SWEENEY, Wilmington, DE (US); Nathan WOLFE, Silver Spring, MD (US); Elijah PINEDA, McLean, VA (US); Benjamin KINGSTON, Taylorsville, UT (US); Ermenildo CASTRO, McLean, VA (US)

(73) Assignee: Capital One Services, LLC, McLean, VA (US)

(21) Appl. No.: 18/641,227

(22) Filed: Apr. 19, 2024

(51) Int. Cl. G06N 3/0455; G06N 3/09

(52) U.S. Cl. CPC G06N 3/0455; G06N 3/09

(57) ABSTRACT

Systems and methods are described for using generative artificial intelligence to automatically label training prompts for training a classification model. Interaction data comprising communications between clients and a chatbot may be used to identify a representative set of topics. Each communication can be assigned a label associated with one or more topics from the set of topics. First training data comprising the set of labels and one or more of the communications assigned to that label may be generated and used to train a generative artificial intelligence model to generate metadata comprising a description of each label from the set of labels. Second training data comprising a plurality of sample prompts, the set of labels, and the metadata; may be generated and used to train a classification model to autonomously label each of the plurality of sample prompts with one or more labels from the set of labels.

### BACKGROUND

Training data is needed to train machine learning models. In particular, high-quality labeled training data is needed. However, subject matter experts are often needed to categorize and label the data to ensure that it is accurate. This complex task can make it time-consuming to generate training data and train machine learning models using that training data. Existing systems attempt to account for the time-consuming nature of generating training data by increasing the number of subject matter experts that may be used for labeling. Unfortunately, this creates a novel technical problem in that an increase in the number of subject matter experts also increases the number of opinions regarding potential labels for a given sample. The result of this is that the labeled training data has more diversity and ambiguity resulting in less accurate and precise data available for training.

### SUMMARY

Client interaction data can include communications between client devices and one or more machine learning models, such as a chatbot. The chatbot can receive a communication, determine an intention of the communication (e.g., what does the client need/want), and perform actions based on the determined intent (e.g., generate and send a response). By analyzing the communications received from clients, trending topics can be identified. These topics represent what a population of individuals may be most interested in at a given time. As such, the topics can change over time (e.g., communications related to football may be received more often in February, whereas communications related to baseball may be received more often in July).

Described herein are techniques for leveraging generative artificial intelligence to label data for training a classification model or other downstream model to perform one or more tasks. Furthermore, the techniques described herein leverage client interaction data and generative artificial intelligence to determine relevant topics into which the data can be categorized. Each topic can then be assigned a label and the labeled training data can be used for training a downstream classification model (or other model) and/or monitoring streaming data for specific events. Moreover, the described techniques overcome the technical problem discussed above by generating labeled training data that may be used to train another artificial intelligence model to autonomously label new training examples accurately and precisely.

In some examples, a generative artificial intelligence model (or, more generally, a classification model) may be used to determine the topics of the client-chatbot communications. The communications may then be labeled based on the identified topics. The generative artificial intelligence model may also rank the topics based on how often those topics appear in the communications. To improve efficiency, the artificial intelligence model may select a subset of those topics based on the ranking (e.g., the top-K topics can be selected). The subset of topics, and the communications classified into each of these topics, may be used as training data to generate another artificial intelligence model to generate metadata for each label. The metadata may include a description of the label, for example, a plain text description. In some examples, the artificial intelligence model used to generate the metadata may be a generative artificial intelligence model.

The labeled data (e.g., the communications labeled with their corresponding topic label and including that topic label's corresponding metadata) may be used to train another artificial intelligence model to autonomously label new training examples. The labeled data may serve as context for this artificial intelligence model such that, when a new training sample is obtained, the model can detect similarities and differences between the new training sample and the labeled data's examples and label the new training sample appropriately. Not only does this allow for faster generation of labeled training data (i.e., minimal to no human intervention is needed), but it removes bias from the labeling process that inherently accompanies human labelers. The newly labeled samples may be used to train one or more downstream classification models, or other artificial intelligence models, or combinations thereof, and/or for monitoring streaming data for particular events.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

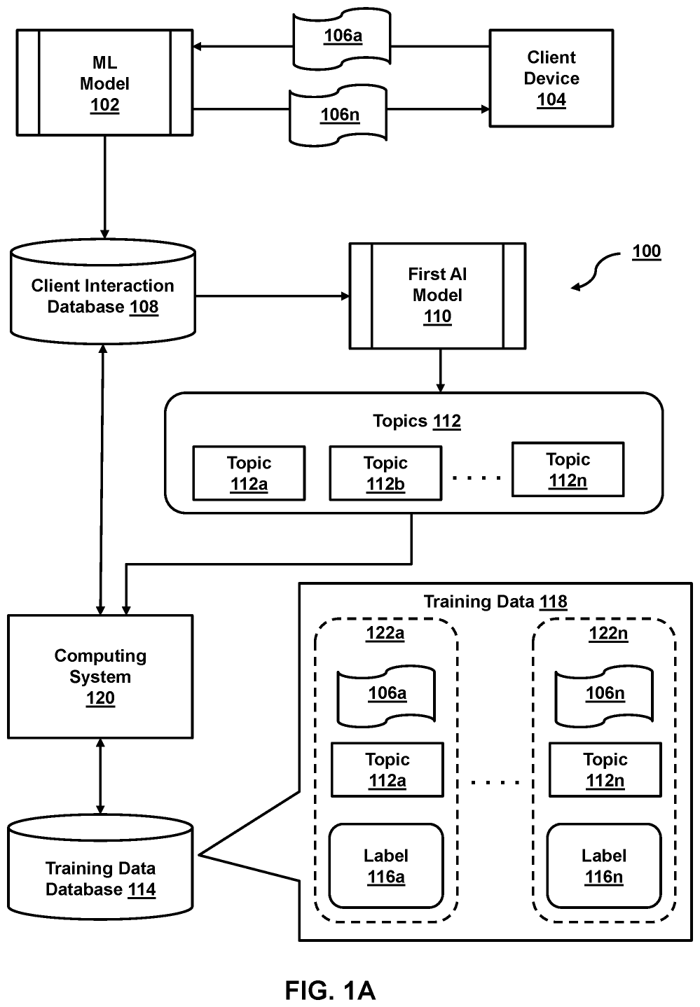

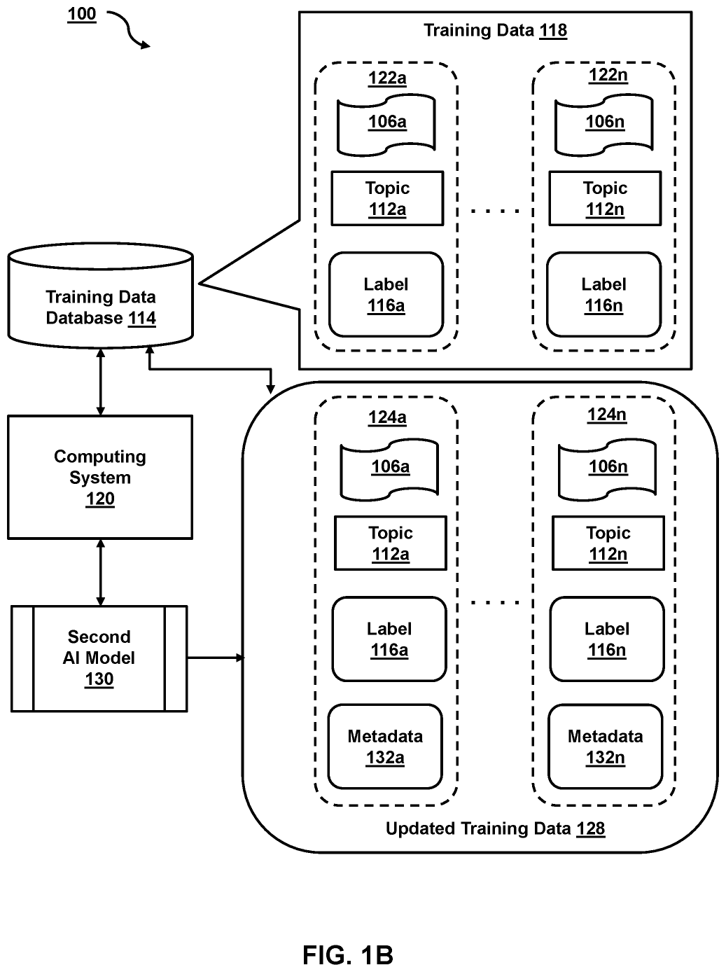

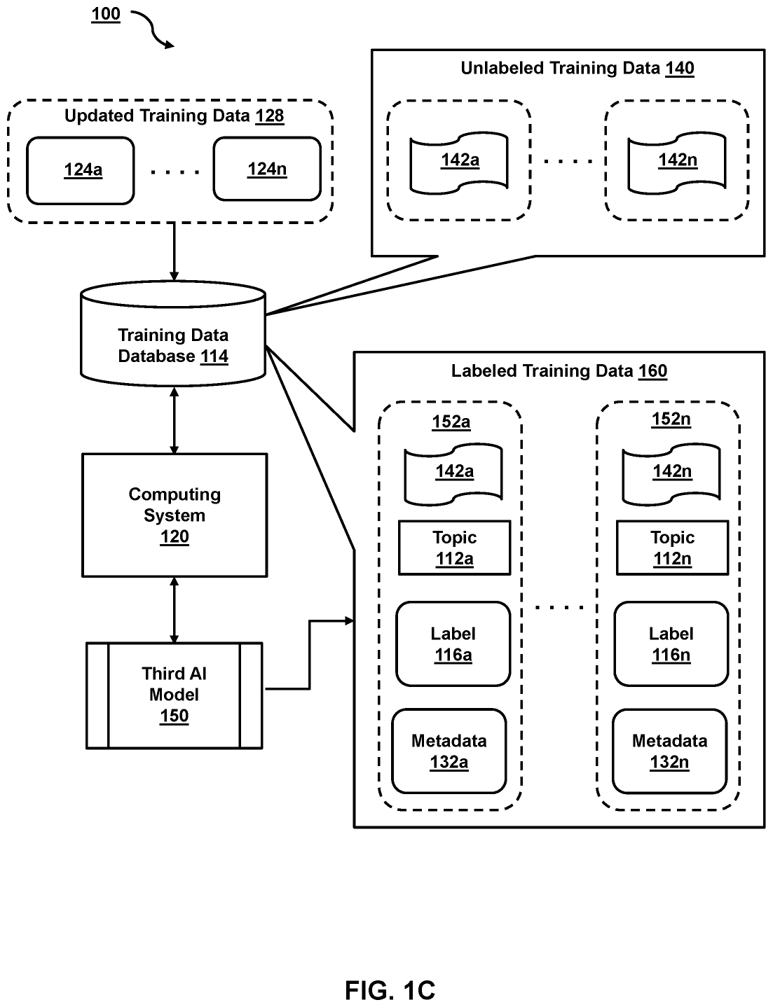

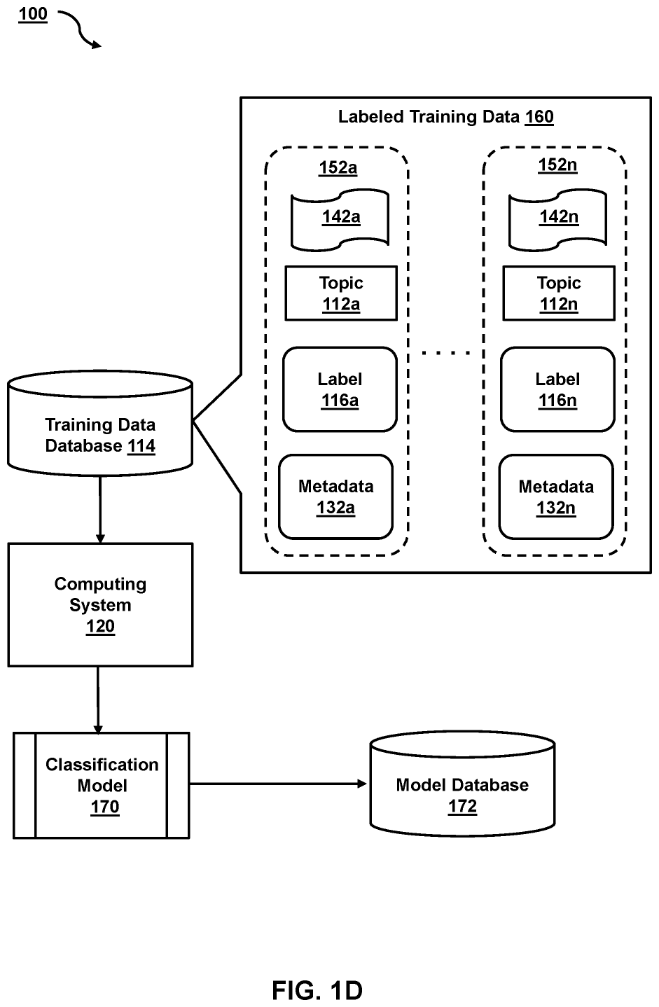

FIGS. 1A-1D illustrate an example workflow for training a model to autonomously label data for generating new training data to be used for downstream classification model training, in accordance with one or more embodiments.

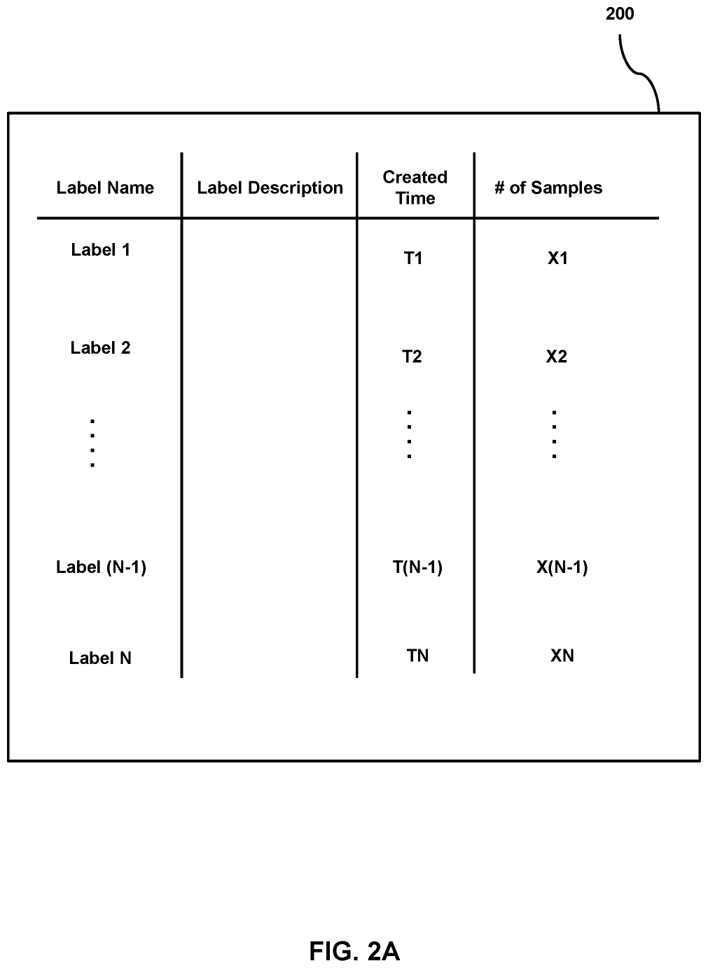

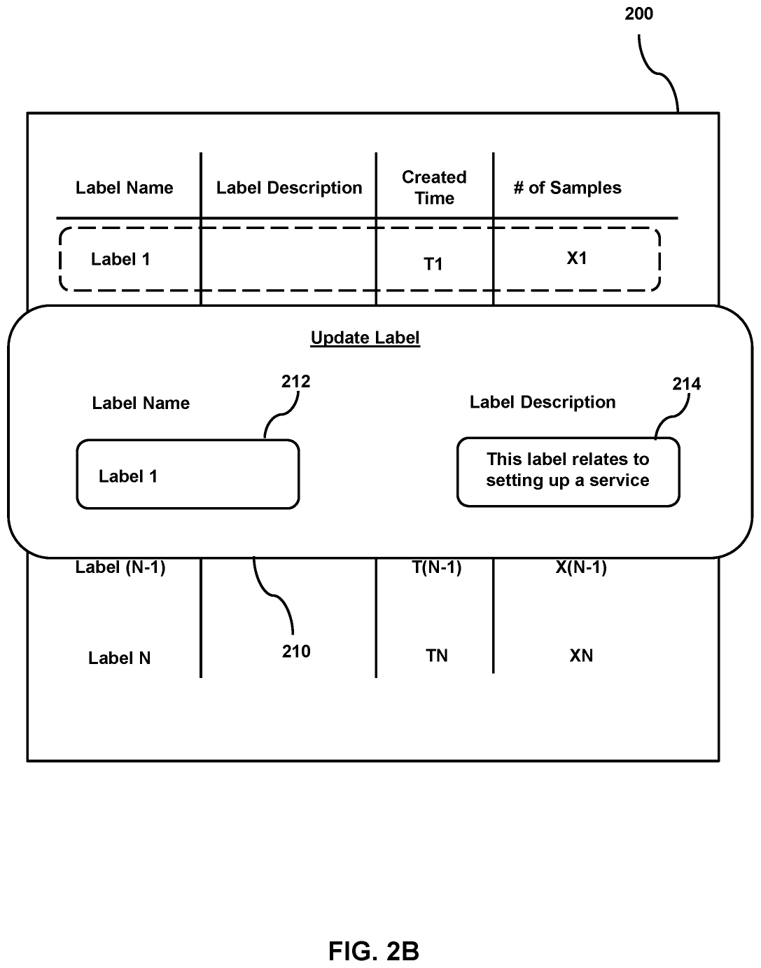

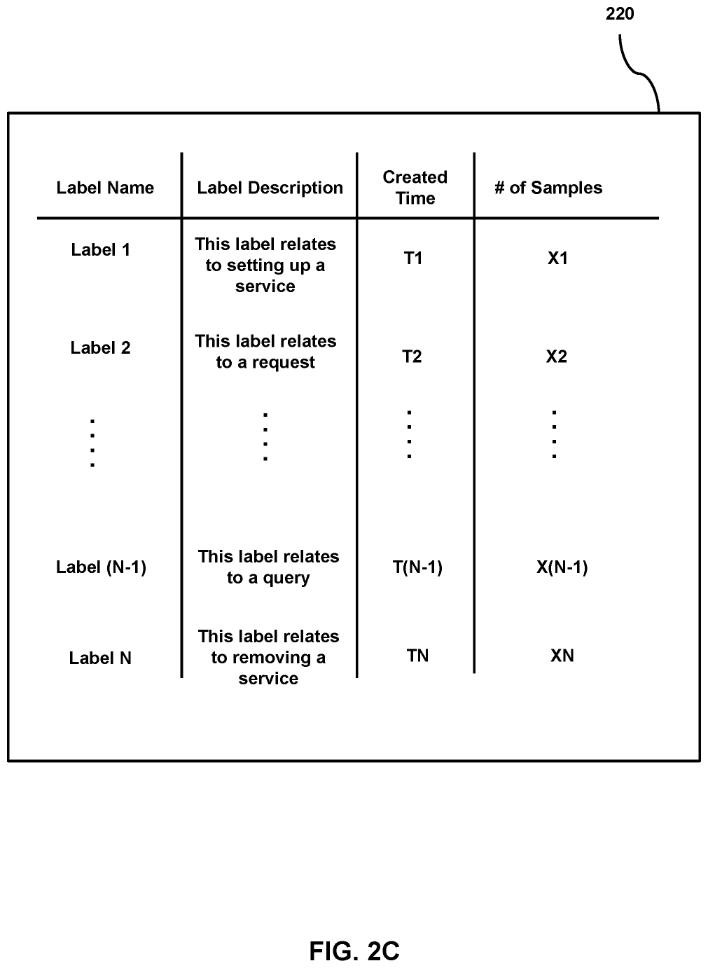

FIGS. 2A-2C illustrate example user interfaces associated with the example workflow, in accordance with one or more embodiments.

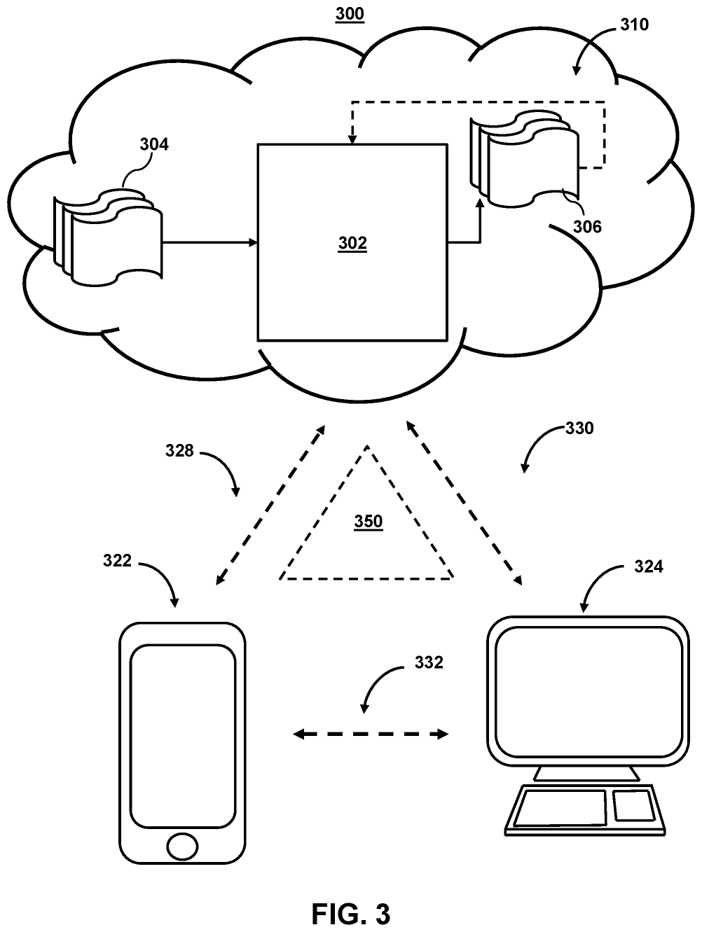

FIG. 3 shows illustrative components for a system used for data labeling, in accordance with one or more embodiments.

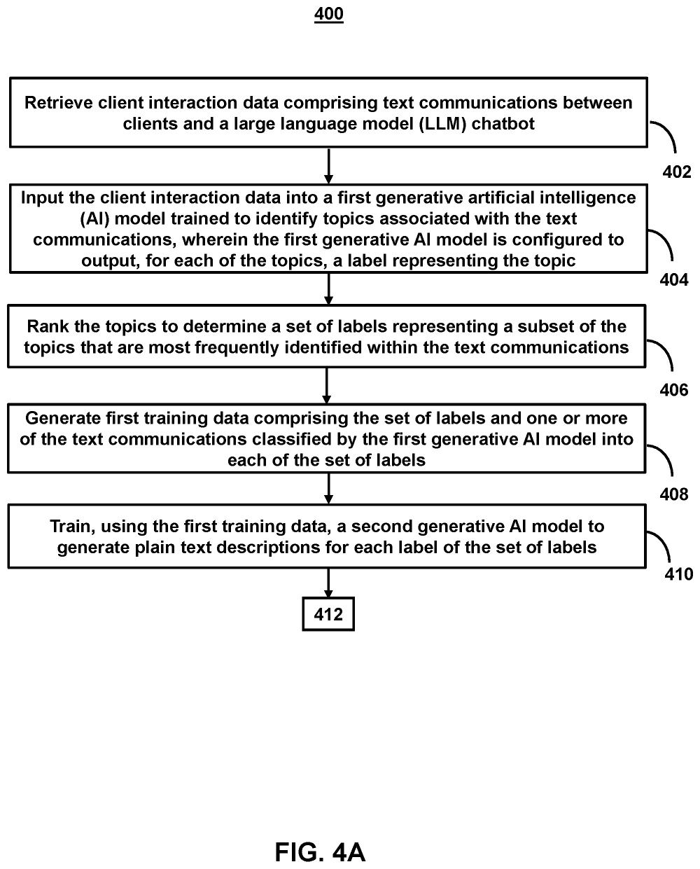

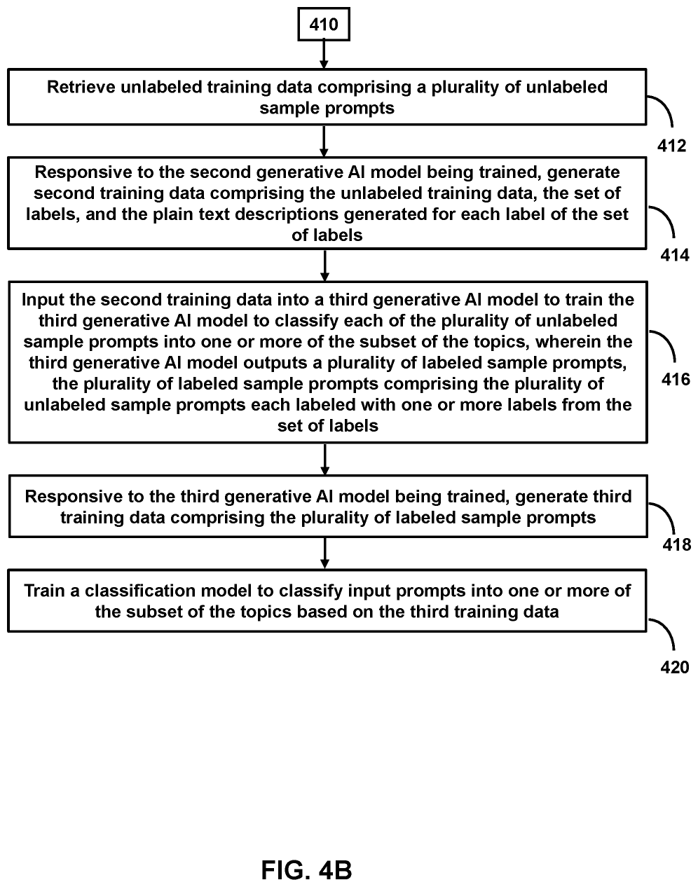

FIGS. 4A-4B illustrate a flowchart of an example process for training a model to autonomously label data for training one or more downstream classification models, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Building machine learning models can be a time-consuming process. This is mostly due to the complexity of the training process and the lack of labeled, high-quality training data. Generally, due to the subject matter expertise needed to accurately label samples, it can be difficult to obtain sufficient training data to facilitate quick model training and deployment. Furthermore, as subject matter experts can have differing opinions on which labels to assign to which samples, the resulting data, inherently, can include some modicum of bias. Thus, a technical problem facing the machine learning community is how to create large quantities of labeled training data in an efficient, inexpensive, and impartial manner.

Described herein are processes leveraging generative artificial intelligence models to autonomously label training data, which can subsequently be used for monitoring streaming data and/or training a downstream classification model or other model. Furthermore, the techniques described herein further leverage generative artificial intelligence models to learn and identify labels and metadata to be used by the other generative artificial intelligence models to label samples. These solutions, along with others described below, enable training data to be generated faster, with increased accuracy and decreased bias, which can result in machine learning models being trained faster, having improved accuracy, and being less biased. Furthermore, as human subject matter experts are not needed (or minimally needed), the overall cost for producing the training data and the machine learning models can be significantly reduced.

Described herein are various machine learning models. Generally, a machine learning model can include any prediction model or other statistical model used to predict a result based on an input based on examples. A machine learning model may include an artificial intelligence model (e.g., a large language model (LLM), a deep learning model, a generative artificial intelligence model, and the like) as well as classification models or other types of models. Thus, persons of ordinary skill in the art will recognize that, unless specifically stated, any instance of a machine learning model, artificial intelligence model, or classification model may be switched with another machine learning model, artificial intelligence model, or classification model, and the present disclosure is not to be construed as limited to the examples recited herein.

FIGS. 1A-1D illustrate an example workflow 100 for training a model to autonomously label data for generating new training data to be used for downstream classification model training, in accordance with one or more embodiments. Workflow 100 of FIGS. 1A-1D may describe an ensemble of processes executed using one or more machine learning models. The workflow described in each of FIGS. 1A-1D may alternatively be performed on its own, however, for illustrative purposes, the operations of workflow 100 are described as a single workflow.

With reference to FIG. 1A, workflow 100 may include a machine learning model 102 configured to communicate with one or more client devices. For example, a client device 104 may send a communication 106a to machine learning model 102, and machine learning model 102 may output a communication 106n to client device 104. Persons of ordinary skill in the art will recognize that a single instance of client device 104 is illustrated solely to avoid obfuscating the figures, and workflow 100 may include any number of client devices (which may be the same as client device 104 or may be different types of client devices).

In some examples, communication 106a may comprise a client-input text communication. For example, communication 106a may comprise text representing a query (e.g., “What is the weather like?”). Communication 106a may also comprise audio and/or video from which text can be extracted at client device 104 and/or machine learning model 102 (e.g., using speech-to-text models).

In some examples, communication 106n may comprise a chatbot-output text communication. As detailed below, communication 106n may represent a model-produced response (e.g., “It is 70 degrees and sunny.”) to an input query (e.g., “What is the weather like?”). In one or more examples, communication 106n may comprise text, audio, video, or other media. Further still, communication 106n may include other data, such as user interface data for rendering a user interface on client device 104, pointers to data files, websites, and the like. Still further, communication 106n may include instructions for performing or causing an action to be performed.

Machine learning model 102 may be a machine learning model configured to interface with client device 104. Machine learning model 102 may operate as a “chatbot,” which corresponds to an intelligent agent configured to respond to requests and queries related to one or more domains. In some examples, machine learning model 102 may comprise a large language model capable of responding to complex prompts with text, images, audio, video, or other data. Client device 104 may communicate with machine learning model 102 via an application programming interface (API) or via other mechanisms (e.g., SMS messaging, email messaging, VOIP communications, etc.). Furthermore, although a single instance of machine learning model 102 is depicted, machine learning model 102 may be composed of multiple models working as an ensemble to respond to communications from clients.

In some embodiments, machine learning model 102 may store interaction data comprising communications between clients and machine learning model 102 (e.g., a chatbot) using client interaction database 108. The interaction data may include, for example, communications 106a and 106n. In some examples, the interaction data stored in client interaction database 108 may further include metadata related to communications 106a and 106n (e.g., a time associated with each, a session identifier (SID) related to a session during which communications 106a and 106n were transmitted, a client identifier (CID) or device identifier associated with client device 104, or other information). The interaction data may be passed to client interaction database 108 in real time or in batches. For example, machine learning model 102 may transmit log files comprising the communications and accompanying metadata to client interaction database 108 at a predefined and/or configurable cadence (e.g., hourly, daily, weekly, monthly, etc.).

Computing system 120 may be configured to retrieve interaction data comprising communications between clients (e.g., client device 104) and a chatbot (e.g., machine learning model 102) from client interaction database 108. Computing system 120 may select which datasets to retrieve and/or may select datasets including communications occurring with a particular period (e.g., communications from a most recent day, week, month, etc.). For example, computing system 120 may retrieve interaction data comprising datasets formed of communications from the last 30 days. Computing system 120 may generate an instruction or otherwise provide the interaction data to a first artificial intelligence model 110.

In some embodiments, first artificial intelligence model 110 may be configured to identify, based on the interaction data, a set of topics 112 represented by the communications. To identify the set of topics (e.g., topics 112), computing system 120 may be configured to input the interaction data into a classification model, an LLM, a generative artificial intelligence model, or other type of machine learning model. For example, first artificial intelligence model 110 may comprise a classification model trained to output topics 112 represented by the communications. As another example, first artificial intelligence model 110 may comprise a generative artificial intelligence model trained to generate topics 112. The generative artificial intelligence model may also function as a classifier to determine topics 112.

In some embodiments, topics 112 may be determined based on the client-input text communications. In one or more example, machine learning model 102, which may be a chatbot, LLM, or the like, may be configured to determine an intent of each of the client-input text communications (e.g., communication 106a) using one or more natural language processing (NLP) models. For example, the chatbot may be trained to generate a corresponding chatbot-output text communication (e.g., communication 106n) based on the intent. In one or more examples, first artificial intelligence model 110 may include NLP models that facilitate determining an intent of the communications. In some embodiments, first artificial intelligence model 110 may be the same or may be in communication with machine learning model 102. For example, machine learning model 102 may determine, itself or using first artificial intelligence model 110, an intent of communication 106a. Each intent may be related to one or more topics 112.

The communications included within the interaction data, and subsequently analyzed by first artificial intelligence model 110, may represent a plurality of topics. For example, topics 112 may include topic 112a, topic 112b, . . . , topic 112n. The number of topics 112 identified may vary. For instance, topics 112 may include 2 or more topics, 10 or more topics, 100 or more topics, etc. In some embodiments, topics 112 may each relate to a particular domain (e.g., a weather domain, a financial domain, a social media domain, a messaging domain, etc.). For example, first artificial intelligence model 110 may be trained to identify topics associated with the weather domain, such as “forecast,” “warnings,” and the like. Alternatively, or additionally, first artificial intelligence model 110 may be trained to identify topics associated with a variety of domains.

In some embodiments, computing system 120 may be configured to rank the plurality of topics based on a frequency with which the communications relate to each of the plurality of topics. For example, first artificial intelligence model 110 may determine that, of the communications analyzed from the retrieved interaction data, 10 communications related to topic 112a, 20 communications related to topic 112n, and so forth. In this example, topic 112n may be ranked ahead of topic 112a based on the number of communications identified for those topics. In some embodiments, the set of topics (e.g., topics 112) may be selected from a plurality of topics identified for all of the analyzed communications. For example, computing system 120 may rank the topics based on the number of communications identified for each, and then may select a top N topics to serve as topics 112. This can allow computing system 120 to use the most popular topics, which can reduce the number of options available for further classifications. Doing so can increase the speed with which training data can be formed. In one or more examples, first artificial intelligence model 110 may comprise a generative artificial intelligence model, and the generative artificial intelligence model can function as a classifier to classify the communications into topics 112.

In some embodiments, first artificial intelligence model 110 may assign one or more labels from a set of labels to each of the communications. The labels may be used to indicate which of topics 112 each communication was classified into. For example, communications classified into a first topic (e.g., topic 112a) may be assigned a first label (e.g., label 116a). In one or more examples, a communication may be assigned two or more labels. This corresponds to a scenario where first artificial intelligence model 110 identified two or more topics with which the communication is able to be classified. For instance, the communication “What will the weather be like for tonight's concert?” may be classified into a first topic (e.g., “weather”) and a second topic (e.g., “music”) and thus may be assigned two labels respectively corresponding to the first and second topics.

In some embodiments, computing system 120 may be configured to generate first training data comprising the set of labels and one or more of the communications assigned to the label. For example, training data 118 may be generated by computing system 120 and may include training items 122a and 122n. Training items 122a and 122n may each include a communication, a topic, and a label. For instance, in the example of FIG. 1A, training item 122a may include communication 106a, topic 112a indicating the topic that communication 106a was classified into via first artificial intelligence model 110, and label 116a assigned to communication 106a based on topic 112a. Similarly, training item 122n may include communication 106n, topic 112n indicating the topic that communication 106n was classified into via first artificial intelligence model 110, and label 116n assigned to communication 106n based on topic 112n. If a communication was classified into two or more topics, then that communication may include labels for each topic.

Computing system 120 may be configured to generate and store training data 118 in training data database 114. Computing system 120 may access training data 118, or other training data, to train one or more machine learning models, as described herein. In some embodiments, training data 118 may include additional metadata, such as a time that the training data was created, times associated with the communications, locations associated with each communication, or other information that can be leveraged for training.

With reference to FIG. 1B, workflow 100 may comprise computing system 120 being configured to training, using training data 118, a generative artificial intelligence model to generate metadata for each label. The metadata may include a description of each label. In one or more examples, the descriptions comprise plain text. By training the generative artificial intelligence model to generate the metadata for each label, workflow 100 reduces the amount of time needed to prepare and develop training data for further downstream tasks. In particular, the creation of descriptions for the labels is traditionally performed by humans. These human annotators generally are subject matter experts in their respective fields. Thus, not only is it time-consuming to have humans create the descriptions for each label but also it is a difficult and expensive processes as not everyone can perform such a task. By leveraging generative AI, workflow 100 overcomes these challenges, making it faster and more efficient to create training data. Further still, as human labelers can often impart their own bias, the generative artificial intelligence described below minimizes and/or eliminates such bias, thereby improving the quality, performance, and neutrality of the model and the subsequent data produced thereby.

In the example of FIG. 1B, workflow 100 may include computing system 120, which can retrieve training data 118 from training data database 114. As mentioned above, training data 118 may include a plurality of training items 122a-122n. Training items 122a-122n may each include a communication (e.g., communications 106a, 106n), an indication of a topic the communication was classified into (e.g., topic 112a, topic 112n), and a label assigned to the communication based on the topic (e.g., label 116a, label 116n). Computing system 120 may retrieve training data 118 and provide training data 118 to a second artificial intelligence model 130. Second artificial intelligence model 130 may be trained to generate metadata, such as, for example, metadata 132a and 132n, for each training item.

In some embodiments, second artificial intelligence model 130 may comprise a generative artificial intelligence model. Generative artificial intelligence models refer to a class of artificial intelligence models that are trained to generate text, images, or other data (e.g., videos). In some embodiments, second artificial intelligence model 130 may comprise a pre-trained generative artificial intelligence model (e.g., Llama). In one or more examples, second artificial intelligence model 130 may comprise an LLM. Second artificial intelligence model 130 may be implemented using various frameworks such as, for example, TensorFlow, PyTorch, Hugging Face, and the like.

In some embodiments, training the generative artificial intelligence model (e.g., second artificial intelligence model 130) may comprise computing system 120 obtaining reference metadata for each label from the set of labels. In one or more examples, the reference metadata may include reference text description contextualizing the label. Using the generative artificial intelligence model, the metadata for each label from the set of labels may be generated. One or more parameters of the generative artificial intelligence model may be adjusted to discriminate between the reference metadata and the metadata for each label from the set of labels. In one or more examples, the model's performance may be evaluated using one or more evaluation metrics such as a BLEU score. In some embodiments, second artificial intelligence model 130 may comprise an adversarial generative artificial intelligence model.

In some embodiments, second artificial intelligence model 130 (i.e., a generative artificial intelligence model) may be trained to generate text descriptions based on training prompts. Second artificial intelligence model 130, for example, may be provided with system prompts as inputs. The system prompts may describe a purpose of a given interaction with second artificial intelligence model 130. For example, if second artificial intelligence model 130 is an LLM, then the system prompt may indicate a purpose of a chat or conversation between a client device and the LLM. After the system prompt is provided, second artificial intelligence model 130 may be provided with individual requests.

As an illustrative example, second artificial intelligence model 130 may receive a system prompt: “You are a system that generates descriptive metadata for datasets. You provide metadata in the following format:
{“description”: <dataset description>
“classes”: [
{“class name 1”: “Class name 1 description”},
. . .
]
}”

After second artificial intelligence model 130 receives the aforementioned system prompt as context, second artificial intelligence model 130 may be provided with individual requests of datasets. As an example, the individual requests may have the following format:
“<sample1>
<sample 2>
. . .
<sampleN>
”

In some embodiments, second artificial intelligence model 130 may be further fine-tuned on this metadata generation task by providing second artificial intelligence model 130 with dataset and metadata pairs until the difference between the two is low.

In some embodiments, second artificial intelligence model 130 may comprise a pre-trained generative artificial intelligence model. The pre-trained generative artificial intelligence model may be a general-purpose generative artificial intelligence model, or a generative artificial intelligence model trained for a particular genre of inputs. Some example generative artificial intelligence models that may be used include LLaMa 2 or Mistral.

Training data 118 may be used to train second artificial intelligence model 130. In some embodiments, training second artificial intelligence model 130 may include iteratively providing training samples (e.g., training items 122a, 122n) to second artificial intelligence model 130. For each sample, second artificial intelligence model 130 may be configured to generate metadata based on a corresponding communication, labels, and/or reference data. As an example, second artificial intelligence model 130 may receive training item 122a, including communication 106a, topic 112a, and label 116a, and may generate metadata 132a comprising a plain text description of label 116a. As another example, second artificial intelligence model 130 may receive training item 122n, including communication 106n, topic 112n, and label 116n, and may generate metadata 132n comprising a plain text description of label 116n. In one or more examples, metadata 132a, 132n may include one or more n-grams, one or more sentences, or other information. As an illustrative example, a label, such as “weather,” may include the description: “This label indicates that the input prompt relates to weather.” As another example, the label “Set Up Autopay” may include the description: “This label indicates that a user seeks to set up an automatic payment.”

In the example of FIG. 1B, data items 122a-122n may be updated to include the metadata generated by second artificial intelligence model 130 to form updated training data 128. In some embodiments, computing system 120 may facilitate the updating, however, second artificial intelligence model 130 may additionally or alternatively update training items 122a-122n. Updated training data 128 may include updated training items 124a-124n, which may respectively correspond to data items 122a-122n of training data 118. In particular, updated training items 124a-124n may include some or all of the data/metadata included within data items 122a-122n, respectively. For example, updated training item 124a may include communication 106a, information regarding topic 112a, and label 116a associated with topic 112a. However, updated training item 124a may also include metadata 132a, generated via second artificial intelligence model 130, which may comprise a plain text description, or other information, associated with label 116a. Similarly, updated training item 124n may include communication 106n, information regarding topic 112n, and label 116n associated with topic 112n. However, updated training item 124n may also include metadata 132n, generated via second artificial intelligence model 130, which may comprise a plain text description, or other information, associated with label 116n.

Referring now to FIG. 1C, workflow 100 may include computing system 120 being configured to generate second training data comprising a plurality of sample prompts, the set of labels, and the metadata. For example, the second training data, which may be used to train a third artificial intelligence model 150, may be formed from updated training data 128 and unlabeled training data 140. Unlabeled training data 140 may include a plurality of sample prompts 142a-142n (e.g., “<sample1>, <sample2>, . . . , <sampleN>”). In some embodiments, third artificial intelligence model 150 may be provided with dataset metadata having a same or similar format as that used for training second artificial intelligence model 130, as mentioned above. In this example, third artificial intelligence model 150 may also be provided with labeled examples and other metadata from a requesting user. Each of sample prompts 142a-142n may be unlabeled. In some embodiments, sample prompts 142a-142n may be derived from real communications (e.g., communications 106a-106n) or may be artificial (e.g., machine-generated). Unlabeled training data 140 may additionally be stored within training data database 114.

In some embodiments, computing system 120 may be configured to retrieve the second training data, including updated training data 128 and unlabeled training data 140, from training data database 114. Computing system 120 may facilitate the training of third artificial intelligence model 150 based on the second training data. In particular, using the second training data, computing system 120 may train third artificial intelligence model 150 to autonomously label each of sample prompts 142a-142n with one or more labels from the set of labels (e.g., the labels associated with topics 112). As seen in FIG. 1C, third artificial intelligence model 150 may be trained to output labeled training items 152a and 152n.

In some embodiments, third artificial intelligence model 150 may comprise a classification model (e.g., a support vector machine (SVM), binary classifier, multi-class classifier, k-nearest neighbors (kNN), decision trees, or other types of classifiers). Furthermore, third artificial intelligence model 150 may comprise a generative artificial intelligence model that generates the labels for sample prompts 142a-142n.

In some embodiments, computing system 120 may be configured to generate, using the classification model, labeled training data comprising the plurality of sample prompts and the one or more labels assigned to each of the plurality of sample prompts. For example, computing system 120 may generate labeled training data 160 using third artificial intelligence model 150, where third artificial intelligence model 150 may assign labels to sample prompts 142a-142n using the set of labels and metadata included within updated training data 128 as context. As an example, third artificial intelligence model 150 may assign label 116a to sample prompt 142a based on a determination that sample prompt 142a relates to topic 112a. Furthermore, based on the assignment of label 116a to sample prompt 142a, metadata 132a, which includes a description of topic 112a, may be associated with sample prompt 142a, thereby forming labeled training item 152a. Labeled training item 152n may be formed using a similar process. For instance, prompt 142n may be assigned label 116n based on prompt 142n being determined to correspond to topic 112n. Metadata 132n may be associated with prompt 142n based on the assignment of label 116n to prompt 142n.

With reference to FIG. 1D, workflow 100 may include computing system 120 being further configured to train a machine learning model using the labeled training data. For example, computing system 120 may facilitate the training of a classification model 170 based on labeled training data 160. Classification model 170 may be used for a variety of different purposes. Alternatively, in one or more examples, computing system 120 may be configured to monitor streaming interaction data for prompts associated with one or more of the set of topics based on the labeled training data.

Classification model 170 may be trained, using labeled training data, to identify one or more events, actions, or other predictions using labeled training data 160. For example, classification model 170 may determine, based on labeled training data 160, whether a given new sample prompt represents a fraudulent action. In one or more examples, a new sample prompt may comprise events associated with a user's account, and classification model 170 may analyze those events to identify a topic associated therewith based on the metadata associated with each topic (e.g., topics 112). In particular, these topics may include the topics determined to be most relevant based on recent trends identified from conversational agents, such as a chatbot or LLM (e.g., machine learning model 102). After training, classification model 170 can be stored in model database 172. Classification model 170 can be invoked via user commands, such as API calls to computing system 120 to access, train, update, and the like, classification model 170.

In some embodiments, computing system 120 may be further configured to retrieve additional interaction data comprising additional communications between clients and machine learning model 102 (e.g., the chatbot). Based on the additional interaction data, one or more additional topics represented by the additional communications may be identified. In one or more examples, the set of labels may be updated to include one or more additional labels respectively associated with the one or more additional topics.

In some embodiments, the additional interaction data may comprise recent communications between clients and machine learning model 102 (e.g., the chatbot). For example, the additional interaction data may comprise communications received from clients by machine learning model 102 within a last N days (e.g., 1 day, 3 days, 7 days, etc.), last N weeks (e.g., 1 week, 2 weeks, 4 weeks, etc.), or last N months (e.g., 1 month, 3 months, 6 months, etc.). In some embodiments, the additional interaction data may be retrieved periodically such that workflow 100 can identify the most frequent topics and learn to autonomously label new data samples based on these trending topics. In some embodiments, new topics may be identified, and subsequently new labels may be created. These new labels may be added to the set of labels based on the frequency with which those new labels are detected within the recent communications between the clients and the chatbot. For example, computing system 120, using machine learning model 102 and first artificial intelligence model 110, may identify trending topics by identifying a frequency with which the recent communications are classified into various topics. If the frequency with which recent communications are classified as being associated with a particular topic is greater than a threshold, then a new label representing that topic may be added to the set of labels used by third artificial intelligence model 150 to autonomously label new input data.

In some embodiments, computing system 120 may be further configured to determine, based on the additional interaction data, that the additional communications include less than a threshold number of communications related to a first topic from the set of topics. In one or more examples, the set of labels may be updated by removing a first label associated with the first topic from the set of labels. As an example, if the recent communications include less than a threshold number of communications classified into the first topic, then computing system 120, using machine learning model 102 and first artificial intelligence model 110, may remove the first label from the set of labels.

FIGS. 2A-2C illustrate example user interfaces associated with the example workflow, in accordance with one or more embodiments. The user interfaces may be rendered on a client device accessing computing system 120. In some embodiments, the user interfaces may be rendered on a display of computing system 120 or in communication with computing system 120. The user interfaces may leverage the generative artificial intelligence techniques described herein to train a model to autonomously label training data, which can subsequently be used for one or more downstream tasks.

With reference to FIG. 2A, a user interface 200 is illustrated including data to be curated for training one or more machine learning models (e.g., machine learning model 102, artificial intelligence models 110, 130, 150, classification model 170, or other models). The data presented within user interface 200 may be structured in a set of columns, including a first column including various label names, a second column including label descriptions respectively associated with the label names, a third column including times with which each label was created, and a fourth column indicating a number of samples identified within client interaction data that were assigned a corresponding label.

In the example of FIG. 2A, one or more (or all) of the labels may lack a description. The description may include a plain text description of each corresponding label. In one or more examples, additional information, such as images, videos, hyperlinks, etc., may also be included within that label's description.

In some embodiments, the label names (e.g., “Label 1,” . . . , “Label N”) may comprise labels generated by one or more generative artificial intelligence models. For example, based on client interaction data including communications between clients and a client-facing chatbot (e.g., machine learning model 102), first artificial intelligence model 110 may be trained to identify topics associated with the communications. Second artificial intelligence model 130 may be configured to generate labels (e.g., labels 116a-116n) based on the identified topics (e.g., topics 112). In some embodiments, one or more of the label names may be input by a human annotator.

In some examples, the label names presented within user interface 200 may include a subset of labels associated with a subset of topics. This may include a randomly selected subset of topics, identified using a randomly selected subset of communications, and/or labels associated with the most frequently identified topics (e.g., top-K topics).

In some embodiments, created times T1-TN, respectively associated with a time labels “Label 1,” . . . , “Label N,” indicate a time that each label was created. The labels, therefore, may be selected based on times T1-TN. For example, only labels created within a particular period (e.g., t₁<T<t₂). In some embodiments, the labels may be sorted in accordance with when they were created.

In some embodiments, the number of samples identified (e.g., X1-XN) for each label may be determined using first artificial intelligence model 110. For example, first artificial intelligence model 110 may track a frequency with which communications are received that relate to a given topic. The number of communications that are received for one topic may be represented by X1-XN, as each communication related to a particular topic is assigned a corresponding label.

The description of a label, however, provides valuable information that contextualizes what a given data sample represents. For example, the label “Set Up Payment Service” can refer to a completely different topic than the label “Weather Inquiry.” Therefore, when developing a model to autonomously label training samples, the label descriptions allow the model to learn topics and label data more efficiently and more accurately.

In some examples, an authorized labeler may input a description for a label. The authorized labeler may, in some embodiments, be a human labeler having subject matter expertise in the domain with which the labeling task relates. However, human labelers can be difficult to find, expensive once found, impart their own bias into their labels, and/or suffer from inefficiencies (e.g., humans require breaks, sleep, food, etc.). Accordingly, as described herein, artificial intelligence models can be trained to autonomously label data samples and assign descriptions, as well as other metadata, thereto.

In some embodiments, with reference to FIG. 2B, a graphical user interface (GUI) 210 may be displayed to allow an authorized labeler to input a description for a label. As mentioned above, the authorized labeler may be a human labeler. However, alternatively or additionally, the authorized labeler may be an artificial intelligence model. Further still, human labelers and artificial intelligence model labelers may be used to cross-check one another, developing a human-in-the-loop reinforcement learning process by comparing model-generated label descriptions with human-generated label descriptions, computing differences between the two, and adjusting model parameters to minimize the computed differences. As seen in GUI 210, a label—Label 1—may be updated to include a label description. Label name field 212, for example, may include the name of the label that is being updated. In some examples, a particular label may be selected using one or more input devices (e.g., a mouse, a touchscreen, etc.), which can result in GUI 210 popping up. GUI 210 may also include a label description field 214. An authorized labeler (e.g., human labeler, model labeler) may be able to provide a description for a label. In some embodiments, a model labeler may generate the label description text, which can be presented within GUI 210 to a human labeler. The human labeler may be able to accept or edit the description. In some embodiments, a consensus of labelers may be needed prior to assigning a particular label and/or label description. For example, more than a threshold number of labelers may need to each, independently, arrive at a same or similar label name and/or label description prior to computing system 120 using that label name and/or label description for classifications.

With reference now to FIG. 2C, updated user interface 220 may include the four columns of data previously presented within user interface 200, however, the label description column may include the label descriptions respectively associated with each label. For example, “Label 1” may include the description “This label relates to setting up a service”; “Label 2” may include the description “This label relates to a request”; “Label (N−1)” may include the description “This label relates to a query”; and “Label N” may include the description “This label relates to removing a service.” In some embodiments, the label descriptions included for each label may be generated using an artificial intelligence model, such as first artificial intelligence model 110. In some embodiments, the label descriptions may be provided by a human labeler. In some embodiments, the label descriptions may include a model-generated description that is edited by one or more human labelers or, alternatively, a human labeler-generated description modified by an artificial intelligence model.

FIG. 3 shows illustrative components for a system used for generating a model to autonomously label data, in accordance with one or more embodiments. For example, FIG. 3 may show illustrative components for data labeling. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as a touchscreen smartphone and a personal computer, these displays also act as user input interfaces. It should be noted that, in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include one or more of the components described in FIGS. 1A-1D. Cloud components 310 may also include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., consistency of labels, predicted labels, version metadata, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. For example, model 302 may represent one or more of machine learning model 102, first artificial intelligence model 110, second artificial intelligence model 130, third artificial intelligence model 150, or classification model 170, and the foregoing description can be applied to any of the aforementioned models. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., consistency of labels, predicted labels, version metadata, etc.).

In some embodiments, the model (e.g., model 302) may automatically perform actions based on outputs 306. In some embodiments, the model (e.g., model 302) may not perform any actions. The output of the model (e.g., model 302) may be used to determine the consistency of labels, predict labels, generate version metadata, etc.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 350 may use various architectural arrangements. For example, system 300 may be partially based on API layer 350 such that there is strong adoption of SOAP and RESTful web services, using resources like Service Repository and Developer Portal, but with low governance, standardization, and separation of concerns. Alternatively, system 300 may be fully based on API layer 350 such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front-end and back-end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDOS protection, and API layer 350 may use RESTful APIs as standard for external integration.

FIGS. 4A-4B illustrate a flowchart of an example process 400 for training a model to autonomously label data for training one or more downstream classification models, in accordance with one or more embodiments. In some embodiments, one or more operations of process 400 may be performed by computing system 120. In some embodiments, one or more operations of process 400 may be performed by, or leveraging, one or more machine learning models, such as machine learning model 102, first artificial intelligence model 110, second artificial intelligence model 130, third artificial intelligence model 150, classification model 170, or other models, or combinations thereof. Further still, one or more operations of process 400 may be performed using other components, such as client devices (e.g., client device 104), a database, a server, and the like. Furthermore, the ordering of process 400 is not restricted to the illustrated embodiment, and one or more operations of process 400 may be performed before or after other operations even if, for example, those operations are labeled as continuous.

In some embodiments, process 400 may begin at operation 402. In operation 402, client interaction data comprising text communications between clients and a large language model chatbot may be retrieved. In one or more examples, audio, video, or other media formats may be included within the client interaction data. For example, with reference to FIG. 1A, communication 106a may comprise text representing a query (e.g., “What is the weather like?”), and communication 106n may comprise text representing a model-produced response to the query (e.g., “It is 70 degrees and sunny”). Communication 106a may also comprise audio and/or video including an utterance of the query, and text representing the query can be extracted using client device 104 and/or machine learning model 102 (e.g., using one or more speech-to-text models). Communication 106n, in this example, may include audio and/or video including model-generated audio and/or video representing the model-produced response to the query (e.g., using one or more text-to-speech models, generative artificial intelligence models, etc.). In one or more examples, communication 106n may comprise text, audio, video, other media, other data (e.g., user interface data for rendering a user interface on client device 104, pointers to data files, websites, and the like), and/or instructions for performing or causing an action to be performed.

Further still, a conversational agent may be used instead of or in addition to an LLM. As an illustrative example, communications 106a, 106n between client device 104 and machine learning model 102 may be stored in client interaction database 108. Computing system 120 may retrieve the client interaction data in response to a request to develop a model to autonomously label data or to another request. In one or more examples, the client interaction data may include recent communications between the clients and the LLM chatbot. For example, the recent communications may include communications received/output within a last N days. Client device 104 may communicate with machine learning model 102 via API, SMS messaging, email messaging, VOIP communications, or other means of communication. In some embodiments, machine learning model 102 may be composed of multiple models working as an ensemble to respond to communications from clients.

The interaction data, for example communications 106a and 106n, may be stored in client interaction database 108 and may include metadata related to the communications. The metadata, for example, may include a time associated with each, a session identifier (SID) related to a session during which the communications were transmitted, a client identifier (CID) or device identifier associated with the client device, or other information. The interaction data may be passed to client interaction database 108 in real time or in batches. For example, machine learning model 102 may transmit log files comprising the communications and accompanying metadata to client interaction database 108 at a predefined and/or configurable cadence (e.g., hourly, daily, weekly, monthly, etc.).

In operation 404, the client interaction data may be input into a first artificial intelligence model. The first artificial intelligence model may, in some examples, be a generative artificial intelligence model. In some embodiments, first artificial intelligence model 110 may be a classifier configured to classify communications into one or more topics 112. In some examples, the communications may represent a plurality of topics 112a-112n. The number of topics 112 identified may vary. For instance, topics 112 may include 2 or more topics, 10 or more topics, 100 or more topics, etc. In some embodiments, topics 112 may each relate to a particular domain (e.g., a weather domain, a financial domain, a social media domain, a messaging domain, etc.). For example, first artificial intelligence model 110 may be trained to identify topics associated with the weather domain, such as “forecast,” “warnings,” and the like. Alternatively, or additionally, first artificial intelligence model 110 may be trained to identify topics associated with a variety of domains.

In some embodiments, the first artificial intelligence model may be trained to identify topics associated with the text communications included within the client interaction data. For example, the first artificial intelligence model (e.g., first artificial intelligence model 110) may include one or more NLP models configured to resolve an intent of a given communication. The topics may indicate a domain with which each communication relates. For example, first artificial intelligence model 110 may determine that communication 106a is related to topic 112a.

In operation 406, the topics may be ranked to determine a set of labels representing a subset of the topics that are most frequently identified within the communications. For example, first artificial intelligence model 110 may determine that, of the communications analyzed from the retrieved interaction data, 10 communications related to topic 112a, 20 communications related to topic 112n, and so forth. In this example, topic 112n may be ranked ahead of topic 112a based on the number of communications identified for those topics. For example, each communication classified into a given topic may cause a counter to be incremented. The number of communications classified into each topic may be used to rank the topics. In some embodiments, a subset of topics may be selected based on the rank. For example, the top N topics may be selected for the subset of topics. Selecting the top N topics can allow computing system 120 to use the most popular topics, which can reduce the number of options available for further classifications. Doing so can increase the speed with which training data can be formed. In one or more examples, first artificial intelligence model 110 may comprise a generative artificial intelligence model, and the generative artificial intelligence model can function as a classifier to classify the communications into topics 112. The set of labels may be determined based on the ranked topics with each topic in the subset of topics being assigned a label. The labels may be used to indicate which of topics 112 each communication was classified into. For example, communications classified into a first topic (e.g., topic 112a) may be assigned a first label (e.g., label 116a). In one or more examples, a communication may be assigned two or more labels. This corresponds to a scenario where first artificial intelligence model 110 identified two or more topics with which the communication is able to be classified. For instance, the communication “What will the weather be like for tonight's concert?” may be classified into a first topic (e.g., “weather”) and a second topic (e.g., “music”) and thus may be assigned two labels respectively corresponding to the first and second topics.

In operation 408, first training data may be generated. The first training data may include the set of labels and one or more of the text communications classified by the first generative model into each label from the set of labels. As an example, first artificial intelligence model 110 may classify each communication from the client interaction data into one of topics 112, and the communications may subsequently be labeled with a label associated with the topic that communication was classified into. For example, training data 118 may be generated by computing system 120 and may include training items 122a and 122n. Training items 122a and 122n may each include a communication, a topic, and a label. For instance, in the example of FIG. 1A, training item 122a may include communication 106a, topic 112a indicating the topic that communication 106a was classified into via first artificial intelligence model 110, and label 116a assigned to communication 106a based on topic 112a. Similarly, training item 122n may include communication 106n, topic 112n indicating the topic that communication 106n was classified into via first artificial intelligence model 110, and label 116n assigned to communication 106n based on topic 112n. If a communication was classified into two or more topics, then that communication may include labels for each topic.

Computing system 120 may generate training data 118 such that each training item (e.g., training items 122a-122n) includes a corresponding communication (e.g., communication 106a) and label (e.g., label 116a). In some embodiments, training data 118 may include additional metadata, such as a time that the training data was created, times associated with the communications, locations associated with each communication, or other information that can be leveraged for training. In some embodiments, computing system 120 may store training data 118 in training data database 114.

In operation 410, a second generative artificial intelligence model may be trained using the first training data. For example, second artificial intelligence model 130 may be trained using training data 118. In some embodiments, a second generative artificial intelligence model may be trained to generate plain text description for each label from the set of labels. By training the generative artificial intelligence model to generate the metadata for each label, workflow 100 reduces the amount of time needed to prepare and develop training data for further downstream tasks. In one or more examples, training items may be provided to second artificial intelligence model 130, which may output candidate metadata, such as one or more descriptions. As mentioned above, training data 118 may include a plurality of training items 122a-122n, which may each include a communication (e.g., communications 106a, 106n), an indication of a topic the communication was classified into (e.g., topic 112a, topic 112n), and a label assigned to the communication based on the topic (e.g., label 116a, label 116n). Second artificial intelligence model 130 may be trained to generate metadata, such as metadata 132a and 132n, for each training item.

Based on the output candidate metadata, and in some cases reference metadata, one or more parameters (e.g., weights, biases) of second artificial intelligence model 130 may be adjusted. This process may be iteratively performed until second artificial intelligence model 130 is determined to have a threshold accuracy. In some examples, one or more parameters of the generative artificial intelligence model may be adjusted to discriminate between reference metadata and the metadata for each label from the set of labels. In one or more examples, the model's performance may be evaluated using one or more evaluation metrics such as a BLEU score. In some embodiments, second artificial intelligence model 130 may comprise an adversarial generative artificial intelligence model.

As an illustrative example of the training, second artificial intelligence model 130 may receive a system prompt: “You are a system that generates descriptive metadata for datasets. You provide metadata in the following format:
{“description”: <dataset description>
“classes”: [
{“class name 1”: “Class name 1 description”},
. . .
]
}”

After second artificial intelligence model 130 receives the aforementioned system prompt as context, second artificial intelligence model 130 may be provided with individual requests of datasets. As an example, the individual requests may have the following format:
“<sample1>
<sample 2>
. . .
<sampleN>
”

In some embodiments, second artificial intelligence model 130 may be further fine-tuned on this metadata generation task by providing second artificial intelligence model 130 with dataset and metadata pairs until the difference between the two is low.

In some embodiments, second artificial intelligence model 130 may comprise a pre-trained generative artificial intelligence model. The pre-trained generative artificial intelligence model may be a general-purpose generative artificial intelligence model, or a generative artificial intelligence model trained for a particular genre of inputs. Some example generative artificial intelligence models that may be used include LLaMa 2 or Mistral.

In one or more examples, metadata generated by the generative artificial intelligence model (e.g., metadata 132a, 132n) may include one or more n-grams, one or more sentences, or other information. As an illustrative example, a label, such as “weather,” may include the description: “This label indicates that the input prompt relates to weather.” As another example, the label “Set Up Autopay” may include the description: “This label indicates that a user seeks to set up an automatic payment.”

In operation 412, unlabeled training data may be retrieved. The unlabeled training data may include a plurality of unlabeled sample prompts. For example, unlabeled training data 140 may include a plurality of sample prompts 142a-142n (e.g., “<sample1>, <sample2>, . . . , <sampleN>”). In some embodiments, the sample prompts may be derived from real communications or may be artificial communications (e.g., machine-generated). In one or more examples, the sample prompts may be similar in structure and format to communications 106a-106n. In some embodiments, the prompts may include plain text.

In operation 414, second training data may be generated in response to the second generative artificial intelligence model being trained. The second training data may include the unlabeled training data, the set of labels, and the plain text descriptions generated for each label from the set of labels. For example, the second training data may include updated training data 128 and unlabeled training data 140. In some embodiments, the second training data including updated training data 128, comprising the set of labels (e.g., labels 116a-116n) and the plain text descriptions (e.g., metadata 132a-132n), and unlabeled training data 140, comprising unlabeled sample prompts 142a-142n, may be stored in training data database 114.

In operation 416, the second training data may be input into a third generative artificial intelligence model to train the third generative artificial intelligence model to classify the unlabeled sample prompts into one or more topics from the subset of topics. For example, the second training data may be input into third artificial intelligence model 150. In some embodiments, third artificial intelligence model 150 may comprise a classification model (e.g., a support vector machine (SVM), binary classifier, multi-class classifier, k-nearest neighbors (kNN), decision trees, or other types of classifiers). Furthermore, third artificial intelligence model 150 may comprise a generative artificial intelligence model that generates the labels for sample prompts 142a-142n.

In some embodiments, the third generative artificial intelligence model may output a plurality of labeled sample prompts. The labeled sample prompts may comprise the unlabeled sample prompts each labeled with one or more labels from the set of labels. For example, each unlabeled sample prompt may be labeled with one or more labels of labels 116a-116n. In some examples, computing system 120 may generate labeled training data 160 using third artificial intelligence model 150, where third artificial intelligence model 150 may assign labels to sample prompts 142a-142n using the set of labels (e.g., “weather,” “music”) and metadata included within updated training data 128 as context (e.g., the label “weather,” may include metadata indicating a description for that label: “This label indicates that the input prompt relates to weather,” the label “Set Up Autopay” may include the description: “This label indicates that a user seeks to set up an automatic payment.”).

In operation 418, third training data may be generated in response to the third generative artificial intelligence model being trained. The third training data may include the labeled sample prompts. For example, labeled training data 160 may be generated using computing system 120. Third artificial intelligence model 150 may assign label 116a to sample prompt 142a based on a determination that sample prompt 142a relates to topic 112a (e.g., the prompt “what is the weather like?” relates to the topic “weather.”). Furthermore, based on the assignment of label 116a to sample prompt 142a, metadata 132a, which includes a description of topic 112a, may be associated with sample prompt 142a, thereby forming labeled training item 152a. Labeled training item 152n may be formed using a similar process. For instance, prompt 142n may be assigned label 116n based on prompt 142n being determined to correspond to topic 112n. Metadata 132n may be associated with prompt 142n based on the assignment of label 116n to prompt 142n. In some embodiments, computing system 120 may store the third training data in training data database 114.

In operation 420, a classification model may be trained to classify input prompts into one or more topics of the subset of topics based on the third training data. For example, classification model 170 may be trained using labeled training data 160. In some examples, the labels from the third training data may be masked to train the classification model. In some embodiments, the classification model may be trained to identify one or more events, actions, or other predictions using labeled training data 160. For example, classification model 170 may determine, based on labeled training data 160, whether a given new sample prompt represents a fraudulent action. In one or more examples, a new sample prompt may comprise events associated with a user's account, and classification model 170 may analyze those events to identify a topic associated therewith based on the metadata associated with each topic (e.g., topics 112). In particular, these topics may include the topics determined to be most relevant based on recent trends identified from conversational agents, such as a chatbot or LLM (e.g., machine learning model 102). After training, classification model 170 can be stored in model database 172. Classification model 170 can be invoked via user commands, such as API calls to computing system 120 to access, train, update, and the like, classification model 170. Alternatively, in one or more examples, computing system 120 may be configured to monitor streaming interaction data for prompts associated with one or more of the set of topics based on the labeled training data.

It is contemplated that the operations or descriptions of FIGS. 4A-4B may be used with any other embodiment of this disclosure. In addition, the operations and descriptions described in relation to FIGS. 4A-4B may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the operations in FIGS. 4A-4B.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for using generative artificial intelligence to automatically label training prompts for training a classification model.
2. The method of embodiment 1, comprising: retrieving interaction data comprising communications between clients and a chatbot; identifying, based on the interaction data, a set of topics represented by the communications, wherein each communication is assigned one or more labels from a set of labels, and each label from the set of labels is associated with a topic from the set of topics; generating first training data comprising the set of labels and one or more of the communications assigned to the label; training, using the first training data, a generative artificial intelligence model to generate metadata comprising a description of each label from the set of labels; generating second training data comprising a plurality of sample prompts, the set of labels, and the metadata; and training, using the second training data, a classification model to autonomously label each of the plurality of sample prompts with one or more labels from the set of labels.
3. The method of embodiment 2, further comprising: generating, using the classification model, labeled training data comprising the plurality of sample prompts and the one or more labels assigned to each of the plurality of sample prompts.
4. The method of embodiment 3, further comprising: training a machine learning model using the labeled training data; or monitoring streaming interaction data for prompts associated with one or more of the set of topics based on the labeled training data.
5. The method of any of embodiments 1-4, wherein the classification model comprises a first classification model, identifying the set of topics comprises: inputting the interaction data into a second classification model to obtain a plurality of topics represented by the communications; and ranking the plurality of topics based on a frequency with which the communications relate to each of the plurality of topics, wherein the set of topics is selected from the plurality of topics based on the ranking of the plurality of topics.
6. The method of embodiment 5, wherein the second classification model comprises a generative artificial intelligence model.
7. The method of any of embodiments 1-6, wherein the communications comprise client-input text communications and chatbot-output text communications, identifying the set of topics comprises: determining, using the chatbot, based on the client-input text communications, the set of topics, wherein the chatbot is configured to determine an intent of each of the client-input text communications using one or more natural language processing (NLP) models and generate a corresponding chatbot-output text communication based on the intent.
8. The method of any of embodiments 1-7, further comprising: receiving a new sample prompt; and inputting the new sample prompt into the classification model to obtain a model-provided label for the new sample prompt.
9. The method of embodiment 8, further comprising: determining a set of user-provided labels assigned to the new sample prompt by a plurality of authorized labelers; determining a first user-provided label of the set of user-provided labels to assign to the new sample prompt based on a number of authorized labelers that assigned the first user-provided label to the new sample prompt satisfying a threshold condition; and assigning, based on a similarity between the first user-provided label and the model-provided label satisfying a similarity condition, the model-provided label or the first user-provided label to the new sample prompt.
10. The method of embodiment 9, further comprising: providing a user interface to each of the plurality of authorized labelers for inputting the set of user-provided labels.
11. The method of any of embodiments 1-10, wherein training the generative artificial intelligence model comprises: obtaining reference metadata for each label from the set of labels, wherein the reference metadata comprises reference text description contextualizing the label; generating, using the generative artificial intelligence model, the metadata for each label from the set of labels; and adjusting one or more parameters of the generative artificial intelligence model to discriminate between the reference metadata and the metadata for each label from the set of labels.
12. The method of any of embodiments 1-11, further comprising: retrieving additional interaction data comprising additional communications between clients and the chatbot; identifying, based on the additional interaction data, one or more additional topics represented by the additional communications; and updating the set of labels to include one or more additional labels respectively associated with the one or more additional topics.
13. The method of embodiment 12, further comprising: determining, based on the additional interaction data, that the additional communications include less than a threshold number of communications related to a first topic from the set of topics; and updating the set of labels by removing a first label associated with the first topic.
14. A tangible, non-transitory, machine-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-15.

What is claimed is:

1. A system for using generative artificial intelligence to automatically label training prompts for training a classification model, the system comprising:
one or more processors programmed to:
retrieve client interaction data comprising text communications between clients and a large language model (LLM) chatbot;
input the client interaction data into a first generative artificial intelligence model trained to identify topics associated with the text communications, wherein the first generative artificial intelligence model is configured to output, for each of the topics, a label representing the topic;
rank the topics to determine a set of labels representing a subset of the topics that are most frequently identified within the text communications;
generate first training data comprising the set of labels and one or more of the text communications classified by the first generative artificial intelligence model into each of the set of labels;
train, using the first training data, a second generative artificial intelligence model to generate plain text descriptions for each label of the set of labels;
retrieve unlabeled training data comprising a plurality of unlabeled sample prompts;
responsive to the second generative artificial intelligence model being trained, generate second training data comprising the unlabeled training data, the set of labels, and the plain text descriptions generated for each label of the set of labels;
input the second training data into a third generative artificial intelligence model to train the third generative artificial intelligence model to classify each of the plurality of unlabeled sample prompts into one or more of the subset of the topics, wherein the third generative artificial intelligence model outputs a plurality of labeled sample prompts, the plurality of labeled sample prompts comprising the plurality of unlabeled sample prompts each labeled with one or more labels from the set of labels;
responsive to the third generative artificial intelligence model being trained, generate third training data comprising the plurality of labeled sample prompts; and
train a classification model to classify input prompts into one or more of the subset of the topics based on the third training data.

2. A method for using generative artificial intelligence to automatically label training prompts for training a classification model, the method being executed by one or more processors of a computing system, the method comprising:
retrieving interaction data comprising communications between clients and a chatbot;
identifying, based on the interaction data, a set of topics represented by the communications, wherein each communication is assigned one or more labels from a set of labels, and each label from the set of labels is associated with a topic from the set of topics;
generating first training data comprising the set of labels and one or more of the communications assigned to the label;
training, using the first training data, a generative artificial intelligence model to generate metadata comprising a description of each label from the set of labels;
generating second training data comprising a plurality of sample prompts, the set of labels, and the metadata; and
training, using the second training data, a classification model to autonomously label each of the plurality of sample prompts with one or more labels from the set of labels.

3. The method of claim 2, further comprising:
generating, using the classification model, labeled training data comprising the plurality of sample prompts and the one or more labels assigned to each of the plurality of sample prompts.

4. The method of claim 3, further comprising:
training a machine learning model using the labeled training data; or
monitoring streaming interaction data for prompts associated with one or more of the set of topics based on the labeled training data.

5. The method of claim 2, wherein the classification model comprises a first classification model, identifying the set of topics comprises:
inputting the interaction data into a second classification model to obtain a plurality of topics represented by the communications; and
ranking the plurality of topics based on a frequency with which the communications relate to each of the plurality of topics, wherein the set of topics is selected from the plurality of topics based on the ranking of the plurality of topics.

6. The method of claim 5, wherein the second classification model comprises a generative artificial intelligence model.

7. The method of claim 2, wherein the communications comprise client-input text communications and chatbot-output text communications, identifying the set of topics comprises:
determining, using the chatbot, based on the client-input text communications, the set of topics, wherein the chatbot is configured to determine an intent of each of the client-input text communications using one or more natural language processing (NLP) models and generate a corresponding chatbot-output text communication based on the intent.

8. The method of claim 2, further comprising:
receiving a new sample prompt; and
inputting the new sample prompt into the classification model to obtain a model-provided label for the new sample prompt.

9. The method of claim 8, further comprising:
determining a set of user-provided labels assigned to the new sample prompt by a plurality of authorized labelers;
determining a first user-provided label of the set of user-provided labels to assign to the new sample prompt based on a number of authorized labelers that assigned the first user-provided label to the new sample prompt satisfying a threshold condition; and
assigning, based on a similarity between the first user-provided label and the model-provided label satisfying a similarity condition, the model-provided label or the first user-provided label to the new sample prompt.

10. The method of claim 9, further comprising:
providing a user interface to each of the plurality of authorized labelers for inputting the set of user-provided labels.

11. The method of claim 2, wherein training the generative artificial intelligence model comprises:
obtaining reference metadata for each label from the set of labels, wherein the reference metadata comprises reference text description contextualizing the label;
generating, using the generative artificial intelligence model, the metadata for each label from the set of labels; and
adjusting one or more parameters of the generative artificial intelligence model to discriminate between the reference metadata and the metadata for each label from the set of labels.

12. The method of claim 2, further comprising:
retrieving additional interaction data comprising additional communications between clients and the chatbot;
identifying, based on the additional interaction data, one or more additional topics represented by the additional communications; and
updating the set of labels to include one or more additional labels respectively associated with the one or more additional topics.

13. The method of claim 12, further comprising:
determining, based on the additional interaction data, that the additional communications include less than a threshold number of communications related to a first topic from the set of topics; and
updating the set of labels by removing a first label associated with the first topic.

14. One or more non-transitory, computer-readable media storing computer program instructions that, when executed by one or more processors of a computing system, effectuate operations comprising:
retrieving interaction data comprising communications between clients and a chatbot;
identifying, based on the interaction data, a set of topics represented by the communications, wherein each communication is assigned one or more labels from a set of labels, and each label from the set of labels is associated with a topic from the set of topics;
generating first training data comprising the set of labels and one or more of the communications assigned to the label;
training, using the first training data, a generative artificial intelligence (AI) model to generate metadata comprising a description of each label from the set of labels;
generating second training data comprising a plurality of sample prompts, the set of labels, and the metadata; and
training, using the second training data, a classification model to autonomously label each of the plurality of sample prompts with one or more labels from the set of labels.

15. The one or more non-transitory, computer-readable media of claim 14, wherein the operations further comprise:
generating, using the classification model, labeled training data comprising the plurality of sample prompts and the one or more labels assigned to each of the plurality of sample prompts.

16. The one or more non-transitory, computer-readable media of claim 15, wherein the operations further comprise:
training a machine learning model using the labeled training data; or
monitoring streaming interaction data for prompts associated with one or more of the set of topics based on the labeled training data.

17. The one or more non-transitory, computer-readable media of claim 14, wherein the classification model comprises a first classification model, identifying the set of topics comprises:
inputting the interaction data into a second classification model to obtain a plurality of topics represented by the communications; and
ranking the plurality of topics based on a frequency with which the communications relate to each of the plurality of topics, wherein the set of topics is selected from the plurality of topics based on the ranking of the plurality of topics.

18. The one or more non-transitory, computer-readable media of claim 14, wherein the communications comprise client-input text communications and chatbot-output text communications, identifying the set of topics comprises:
determining, using the chatbot, based on the client-input text communications, the set of topics, wherein the chatbot is configured to determine an intent of each of the client-input text communications using one or more natural language processing (NLP) models and generate a corresponding chatbot-output text communication based on the intent.

19. The one or more non-transitory, computer-readable media of claim 14, wherein the operations further comprise:
receiving a new sample prompt; and
inputting the new sample prompt into the classification model to obtain a model-provided label for the new sample prompt.

20. The one or more non-transitory, computer-readable media of claim 19, wherein the operations further comprise:
determining a set of user-provided labels assigned to the new sample prompt by a plurality of authorized labelers;
determining a first user-provided label of the set of user-provided labels to assign to the new sample prompt based on a number of authorized labelers that assigned the first user-provided label to the new sample prompt satisfying a threshold condition; and
assigning, based on a similarity between the first user-provided label and the model-provided label satisfying a similarity condition, the model-provided label or the first user-provided label to the new sample prompt, wherein a user interface is provided to each of the plurality of authorized labelers for inputting the set of user-provided labels.
